(19) United States
(12) Patent Application Publication
(10) Pub. No.: US 2004/0035232 A1
(43) Pub. Date: Feb. 26, 2004

(54) Plews impulse drive

(76) Inventor: Dennis J. Plews, Bradenton, FL (US)

Correspondence Address: Yate K. Cutliff, Pendorf & Cutliff, P.O. Box 20445, Tampa, FL, 33622-0445, US

(21) Appl. No.: 10/225,984

(22) Filed: Aug. 22, 2002

(51) Int. Cl. F16H 27/04

(52) U.S. Cl. 74/84 S

(57) ABSTRACT

An impulse drive for converting inertial and rotational energy into linear motion includes a pair of thrust mass bearing race, with one of the pair of thrust mass bearing race attached to the interior of the top circular bearing ring and another of the pair of thrust mass bearing race attached to the interior of the bottom circular bearing ring, an inner circular bearing ring is coupled to the pair of thrust bass bearing race and have movable arc segments that move into and away from the path of thrust mass that move radially freely within cavities of a rotating circular disk, the rotating circular disk is moved by a axle drive that varies the rotational velocity of the disk, a mass accelerator girdle is positioned exterior the inner circular bearing ring and coupled to the interior of the top and bottom circular bearing rings, with mass accelerators fastened into the mass accelerator girdle and positioned over pistons of the movable arc segments in such a fashion that the amount of force needed to accelerate the trust masses, and the resulting thrust generated by the device is contained and controlled.

### BACKGROUND OF THE INVENTION

1. Field of Invention:

The present invention relates to an impulse device and more particularly pertains to mounting freely movable masses about the periphery of a circular disk which is in turn mounted onto a main rotational axis drive shaft, whereby energy is provided to cause the circular disk to rotate at high speeds, while having the ability to move the freely movable masses radially toward and away from the axis of rotation. The invention further relates to a new method of converting inertial and rotational energy, as generated by an engine or motor, into linear motion.

2. Description of the Related Art:

Current transportation technologies use a variety of mechanisms to convert the rotational energy generated by the engine or motor contained within the vehicle into the linear motion of the vehicle. In the automotive world there are three basic forms of the mechanical device generally known as a transmission that is connected to the motor/engine and in turn itself is connected to a drive shaft and gear assembly that ultimately attaches to the drive wheel(s) (the drive train) to produce the motion of the vehicle. The three basic varieties of an automotive transmission are manual, automatic and continuously variable, with the manual transmission generally being the most efficient form for transmitting the motor/engine power to the drive wheel(s).

In a conventional manual transmission, the driver mechanically selects a particular gear ration for the manual transmission by disengaging a friction clutch and moving a shift lever to a predetermined position to engage the desired gear ratio. For example, a conventional 4-speed manual transmission is known to utilize a shift mechanism wherein a first shift fork is connected to and moves a first clutch ring or synchromesh unit to engage a first or second speed driven gear, and a second shift fork is connected to and moves a second clutch ring or synchromesh unit to engage a third or fourth speed driven gear of the transmission. Manual transmissions of the type utilized in connection with high performance automobiles, such as those used in connection with professional racing include a lay shaft. It is used to facilitate quicker acceleration from a rolling start and to minimize the power necessary to accelerate the automobile, it is also known to use a reduction or drop gear on the lay shaft of the transmission in order to increase the rotational speed of the gear train within the transmission.

Generally, in control of a modern automotive automatic transmission is the rotational speed of an input shaft and an output shaft thereof which are monitored by sensors. The output shaft rotational speed may be monitored at a location outside of the transmission and the input shaft rotation is generally monitored at a location within the automatic transmission. An example of such a conventional automatic transmission employing rotational sensors is disclosed in Mitsubishi Juukou Gihou (Mitsubishi Industrial Technique) Vol. 21 No. 1 (1984 by Mistubishi Industrial Company Publications) wherein an input shaft of the automatic transmission rotates in connection with a clutch drum. According to this disclosure, a brake band is wound around the outer circumference of the clutch drum and a rotational sensor for detecting rotation of the drum is positioned adjacent the brake band. According to the above, since the rotational sensor must be positioned so as not to interfere with the brake band, i.e. adjacent the brake band, the transmission becomes large in an axial direction thereof. Improvements in an automatic transmission are taught by U.S. Pat. No. 6,375,592, wherein included in the automatic transmission are planetary gear units with each incorporating a centrifugal clutch.

The basic principle of a continuously variable toroidal transmission has already been described in U.S. Pat. No. 2,152,796 which was published in the year 1939. In said publication, two pairs of concave input and output discs are provided between which tiltably supported toroidal wheels are situated so that a torque transmitted, via an input shaft to the input discs, and the toroidal wheels, in accordance with the relative position of the toroidal wheels with a reduction ratio depending thereon, is fed in the form of a planetary gear to a summarizing transmission, via the output discs, a gear stage and a hollow shaft. The carrier of the planetary gear drives an output shaft, which is connected with the driving wheels, for example, of a motor vehicle. The output shaft is situated parallel to and spaced from the input shaft. The output gearwheel and both output discs are rotatably placed on a sleeve, which on its ends, is supported in bearing brackets. The arrangement of the bearing brackets, between each input and output discs, presupposes a sufficient large installation space between said discs.

In aircraft the choices for converting engine power output into vehicle motion are propellers and j et engine thrust from j et engines such as turbofan engines or turbojet engines. There are combination engine systems which have a main gas generator of the turbofan type in which the low pressure fan is selectively utilized to provide supercharged air to the main gas generator, i.e., compressor, combustor and turbine, and bypass air that can be used either as fan bypass for the main gas generator or as a supply of air for an auxiliary gas generator. The engine system is preferably fully integrated with the variable air inlets and exhaust nozzles by a control system.

In watercraft, propellers dominate with only a few specialty use vessels being propelled by jet thrust or aircraft style engines of the propeller type. Traditional propeller engines that are either outboard or inboard type dominate the market.

Each of these technologies suffer significant power losses, and resulting energy inefficiencies, when using current technologies for converting the angular momentum generated by the engine/motor. For example, a typical manual automotive transmission and drive train will lose 15-18% of its flywheel horsepower by the time it reaches the drive wheel. Most automobile manufacturers will state the vehicle's engine horsepower by listing the power measured at the flywheel. For example, late 1980's 302 cubic inch displacement Ford Mustang engines with manual shift transmissions and friction clutches were rated at 225 HP, but on a chassis dynamometer which measures rear-wheel horsepower, they produce about 190 HP. The missing 35 horsepower is consumed by the friction generated in the drive train. There is more power loss with an automatic transmission than there is with a manual transmission as the power to actuate the internal clutches and shift the gears comes from the engine/motor. The torque converter also consumes significant amounts of the engine/motor output which is radiated away as heat. In addition to permitting a car come to a complete stop without stalling the engine, the torque converter actually gives a car more torque when it accelerates from a stop. Modern torque converters can multiply the torque of the engine but this only happens when the engine is turning faster than the transmission. At higher speeds, the transmission catches up to the engine, eventually moving at almost the same speed. Ideally, though, the transmission would move at exactly the same speed as the engine, because this difference in speed wastes power. This is part of the reason why cars with automatic transmissions get worse gas mileage than cars with manual transmissions. To counter this effect, many passenger vehicles now have a torque converter with a lockup clutch that eliminates the slippage and improves fuel efficiency, while operating in the highest gear range.

Aircraft propeller efficiency varies according to the shape of the propeller and the angle of incidence of the propeller. In every case the amount of energy used to spin the propeller is significantly greater than the amount of thrust produced. Jet engine efficiency similarly suffers losses between the input of the fuel's energy and the output of the thrust energy. Moreover, propeller aircraft suffer significant efficiency losses as altitude increases.

Marine propellers have thrust to input power ratios similar to aircraft propellers with the additional problem of corrosion and encrustation thrust losses not suffered by aircraft propellers.

Accordingly, the present inventor felt that there existed a need for a highly efficient device that would solve the problems of fuel inefficiency, excess energy consumption and reduce friction wear of operable parts. In this regard, the present invention substantially fulfills this need.

### BRIEF SUMMARY OF THE INVENTION

After extensive study of various inertial systems, the present inventor discovered that conventional means of converting the input energy of an engine or motor into thrust that propelled a vehicle could be eliminated. Specifically, it is the object of the present invention to replace existing automotive transmissions and drive trains, and aeronautical and marine propellers.

Accordingly, a primary purpose of the impulse drive is to convert inertial and centrifugal rotational energy of the freely movable thrust masses into linear motion with increased thrust output. As such, the general purpose of the present invention, will be described subsequently in greater detail.

The impulse drive device includes a drive axle that is connected to an external engine motor. A top circular bearing ring and a bottom circular bearing ring are coupled to the drive axle. A main part of the bearing rings are a pair of thrust mass bearing race one of the pair of thrust mass bearing race is fixedly attached to the interior of the top circular bearing ring, another of the pair of thrust mass bearing race is fixedly attached to the interior of the bottom circular bearing. Coupled to the pair of thrust mass bearing race and the top and bottom circular bearing rings is an inner circular bearing ring. Positioned within the inner circular bearing ring is a means for rotating about the drive axle and within the pair of thrust mass bearing race so to engage the internal side of the inner circular bearing ring. The means for rotating about the drive axle has a central lumen through which the drive axle passes and attaches thereto. Further included is a surrounding cage that has a plurality of mass accelerators positioned therethrough. Furthermore, included is a means for sequentially activating one or more of the plurality of mass accelerators so that the activated mass accelerators engage externally a segment of the inner circular bearing so that it presses against the means rotating about the drive axle thereby producing a thrust vector that provides the amount and direction of trust.

To attain the linear motions of the device, the present invention essentially comprises an arrangement of freely movable masses that are constrained to move in a circle at high speeds but which also have the ability to freely move radially toward and away from the axis of rotation. The movement of these masses toward the rotational axis is induced mechanically through cams or cam like devices, or by any other suitable method such as electromagnetic field modulation, that increase the individual mass's centripetal acceleration at specific sites about the circumference of the circle about which the movable masses are spun. This induced asymmetrical additional centripetal acceleration, by the operation of Newton's laws of motion, produces an oppositely directed reaction in the device, which is the source of what commonly known as thrust. The number of the movable masses, elsewhere referred to herein as thrust masses, and the number of actuating cams or other similarly functioning devices, elsewhere referred to herein as mass accelerators that are being activated, as well as the size of the circle about which the thrust masses move and the speed of rotation, can be varied to fit the specific application under contemplation. As the invention is mechanical in nature, an oiling system is required, as well as an enclosing shell that protects the moving parts from contamination and collects and reuses the oil.

Energy to rotate the movable masses and actuate the mass accelerators is externally supplied, thus complying with the conservation of energy laws. The mass accelerators may easily be powered by commercially available hydraulic pumps, pistons and valves, which themselves are powered by commonly available electric motors or fossil fuel engines. In the version described herein it is contemplated that a single, external source us used to provide all needed power to the invention. The mass accelerators can be computer controlled to fit the performance needs of the operator. Since the mass accelerators may be positioned anywhere to intercept the motion of the thrust masses about the periphery of their circular motion, the thrust vector produced can be varied at the direction of the operator. Since there are few moving parts that move against other component parts, friction is minimized. As the thrust that is produced by the invention can cause any device to which the invention is attached to move, such as motor vehicles, boats and aircraft, without any need for additional devices, the inherent inefficiencies of automotive drive trains and propellers are avoided, thus markedly improving fuel efficiency throughout the transportation industry. Since the device is significantly less massive than passenger vehicle's transmission and drive train, substantial weight savings are achieved with the added benefit of further increasing fuel efficiency.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

It is therefore an object of the present invention to reduce power loss and increase energy efficiency when converting the energy generated by the engine/motor into linear motion.

Another object of the present invention to provide a new impulse drive device with greater trust for movement of any transport apparatus.

It is an object of the present invention to provide an impulse drive that may be easily and efficiently manufactured and marketed.

A further object of the present invention to provide environmental benefits resulting from increased energy efficiency in the transportation industry.

Another object of the present invention is to provide economic benefits resulting from the reduced cost of production of the invention as compared to the cost of the production of automotive drive trains.

Still another object of the present invention is to reduce the cost of automobiles to the consumer due to the reduced production cost of motor vehicles that utilize the invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying Figures and descriptive matter in which there is illustrated preferred embodiments of the invention.

### BRIEF DESCRIPTION OF THE DRAWINGS

The present invention will be explained in greater details with reference to the Figures.

NOTE REGARDING ALL FIGURES: As the dimensions required for manufacture of the device vary according the desired operation parameters, construction materials and thrust requirements, the following descriptions and Figures are not to scale. When constructing the invention, the performance specifications and size limitations will dictate the diameter of the main bearing ring which then determines all other dimensions of the components of the invention.

FIG. 1 is a sectional plan view of the impulse drive according to the present invention.

FIG. 2 is a perspective view of the impulse drive according to the present invention.

FIG. 2a is a partial side view, similar to FIG. 2, with the mass accelerator girdle removed to show details of the present invention.

FIG. 3 is an enlarged detailed view of a sectional portion of FIG. 1, which shows the movement direction of the movable bearing arc segment as it is engaged by the corresponding mass accelerator.

FIG. 3a is an enlarged detail view of that portion of FIG. 2a, which shows the pre positioning of the movable bearing arc segment with the mass accelerator being free of the mass accelerator girdle.

FIG. 4 is a side sectional view of the device taken along the line 4-4 of FIG. 3, showing the movable bearing arc segment with the mass accelerator of the present invention at rest.

FIG. 5 is a perspective view of an array of impulse drives connected to a power supply and a central gear box by drive axles.

FIG. 6 is an exploded view of the top and bottom disks that have the two circular bearing rings and showing the bottom disk thrust mass bearing race positioned on the bottom disk. Also depicted are portions of the mass accelerator girdle.

Similar reference characters refer to similar parts throughout the several views of the Figures.

### DETAILED DESCRIPTION OF THE INVENTION:

The impulse device 10 of the present invention represents a significant advance over the current methods used by transportation technologies to convert the rotational energy generated by an engine or motor into linear motion. The invention is intended to replace existing automotive transmissons and drive train assemblies and aeronautical and marine propellers.

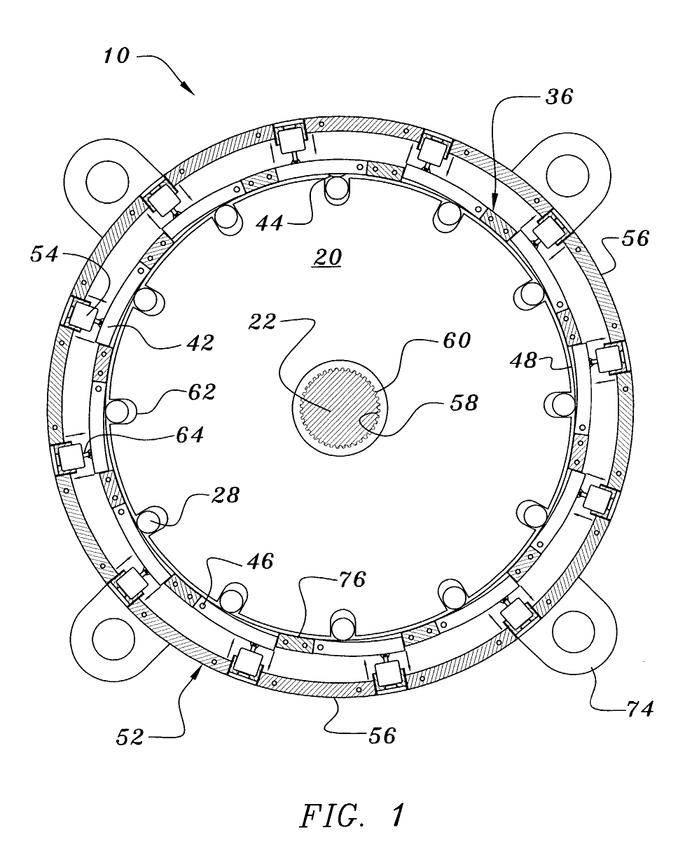

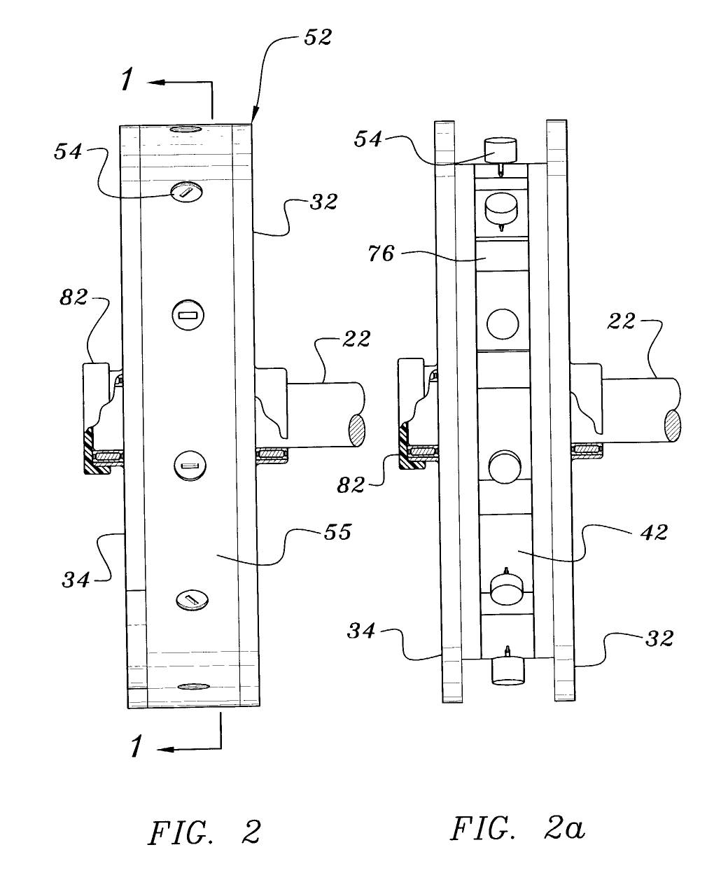

Specifically, as partially shown in FIGS. 1 and 2, the invention consists of a circular disk 20, a main rotational axle drive shaft 22 onto which the circular disk is mounted and through which rotational energy is provided by connecting the drive axle shaft to an external engine or motor 26 by currently used methods, multiple movable cylindrical masses 28, two circular bearing rings 32 and 34 that sandwich a centrally positioned inner circular bearing ring 36 made of individual, movable bearing arc segments 42 that have acceleration humps 44 on the internally facing surface and each one is fixed at one end by a pivot shaft 46 that passes through the thrust mass bearing race 48; and a surrounding cage 52 upon which are mounted devices that connect to a component of each movable bearing arc segment at the end furthest from the acceleration hump, which cause the movable bearing arc segments to pivot toward and away from the rotational axis of the circular disk.

The drive axle of FIGS. 1, 2 and 2a has a splined area 58 for mating to a corresponding area 60 of a single rotating disk and main bearing surfaces on drive axle. The drive axle and rotating disk have lubrication passageway openings (not shown). The splined area has shoulder that acts as a travel stop to position the rotating disk at one end. The rotating disk has set screws (not depicted) to hold the disk firmly against its travel stop. Multiple rotating disks can be added to a given embodiment of the device. Such additional rotating disk applications will vary the physical dimensions of the invention by requiring the drive axle to be lengthened to accommodate additional disk widths and the associated additional circular bearings, movable bearing arc segments, mass accelerators, thrust masses and mass accelerator girdle widths.

The entire device is lubricated in a typical automotive fashion using oil passageways in the rotational axis drive shaft and circular disc so that the three adjacent bearing surfaces upon which the moveable masses 28 ride and the portion of the circular disk that enclose the several thrust masses 28 and the thrust mass themselves are continuously supplied with lubrication.

When fully assembled, the entire device then has an encapsulated, cylindrical container (hereinafter referred to as the inner or primary cage structure) that acts as a catchment and return system (not depicted) for the lubricant and which protects the moving parts from contamination by foreign matter such as abrasive particulates. The inner cage structure 37 has openings at either end adequate for the passage of the drive axle shaft at each of which is a bearing that fixes the shaft in position and automotive type oil seals that seal the bearings and such other openings as are needed for the lubrication of the device and the provision of power to and control of the mass accelerators that are mounted to the mass accelerator girdle 55 and surrounding cage 52 and which move the individual movable bearing arc segments. It is important to note that the inner cage structure is formed by the coupling of the two circular bearing rings 32, 34, with the spacers and the movable bearing arc segments 36 that are coupled to the thrust mass bearing race 48.

Included is a rotating circular disk 20, and as shown in FIG. 1, it has a splined center lumen 60 through which the drive shaft passes. Further, the thrust mass cavities 62 are arranged about the periphery of the rotating disk, with the inner surfaces of each thrust mass cavity having a bearing surface with lubrication passageway openings that communicate with the lubrication passageway openings that pass through the body of the rotating disk to the splined area. The number of thrust mass cavities depicted is arbitrary as the number needed for a particular application will vary in number and size.

The circular disc 20 and its associated axis drive shaft 22 rotates about its central axis with the movable thrust masses radially mounted near the periphery of the rotating disk within the physical dimensions of the rotating disc. Each thrust mass is mounted such that it can freely move radially toward and away from the axis of disc rotation from the innermost travel stop, which is the bottom of the thrust mass cavity 62, to the outermost travel stop consisting of the circular bearing races 48, which is formed by the circular bearings that are a physical part of the top and bottom disks 32, 34 and which are near to the periphery of the rotating disk 20. The thrust masses are sequentially accelerated towards the rotating disk's 20 axis of rotation at well defined times and in a continual sequence by mass accelerators 54 which are mounted into the mass accelerator girdle 55 that is around the disk 20 and encircling bearing races in such a fashion that the amount of force needed to accelerate the thrust masses, and the resulting thrust generated by the device, is contained and controlled.

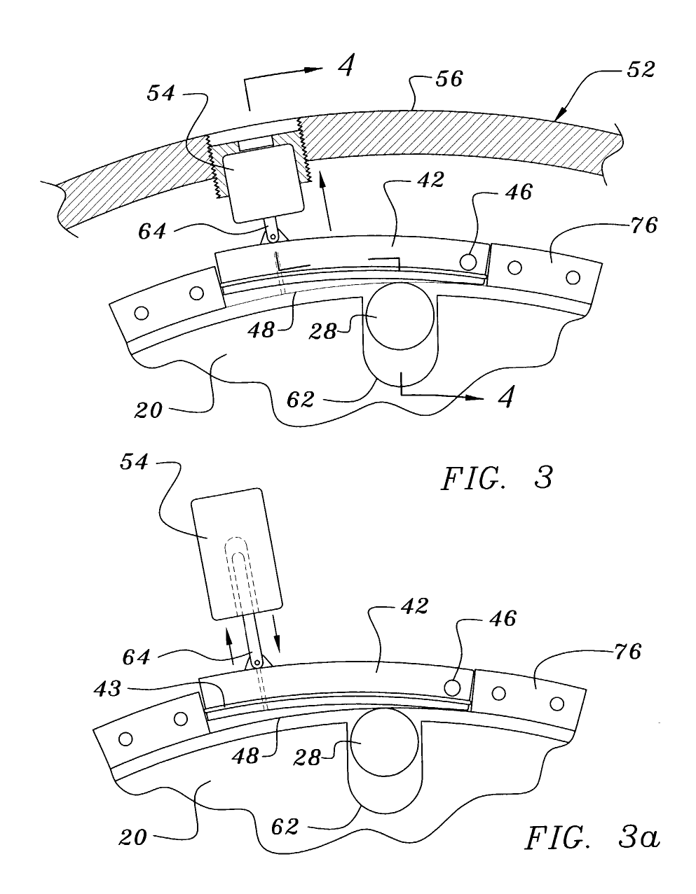

Multiple mass accelerators 54 are mounted as seen in FIG. 1, each of which can be sequentially activated at the desired time and for the desired duration by a signal from an outside source. The mass accelerators can be hydraulic, mechanical, electromechanical or electromagnetic actuators. The mass accelerators are mounted on the girdle segments 56 that form the mass accelerator girdle 55 of the surrounding cage structure 52, and external to the rotating disc 20. The depicted mass accelerators 54 have a piston 64 contained within them, each of which is attached to the movable bearing arc segment at a specific point as shown in FIGS. 3 and 3a. Each mass accelerator and movable bearing arc segment is placed at the location(s) necessary to produce the desired thrust vector. By varying the rotational velocity of the disk, the amount of inward acceleration imparted to the thrust masses by the action of the mass accelerators and the timing of the activation of the mass accelerators, the resulting thrust vector that is generated can be varied to provide the desired amount and direction of thrust. For example; if mounted to a wheeled platform, the invention can accelerate the platform, change the direction of motion of the platform and bring a moving platform to a stop, without being connected in any way to the wheels.

The movable bearing arc segment 42 as shown in FIGS. 3 and 3a, has a pivot point hole through which the pivot shaft passes 46. The external surface 66 of movable bearing segment (convex side) has attachment site for connection to the mass accelerator which is itself coupled with the mass accelerator girdle of FIGS. 1 and 3. The acceleration hump 44 apex, see FIG. 1, is on the internal (concave) side of the movable bearing segment. The hump is placed at a position on the movable bearing segment such that the distance between the center of the mass accelerator piston attachment point to the movable bearing arc segment and the movable bearing arc segment pivot point is approximately three or more times the distance between the movable bearing arc segment pivot point and the apex of the acceleration hump, creating a leverage advantage that reduces the amount of force required to the movable bearing arc segment by the mass accelerator. This ratio can be varied according to the performance requirements for the particular device under construction.

In FIG. 2 it is shown that the mass accelerator girdle, formed by a series of attachment plates or girdles, is firmly attached to the two circular bearing ring disks to form the surrounding cage 52 for the movable components of the impulse device. The actual form of the mass accelerator girdle can be varied according to individual preferences or performance requirements. The encircling mass accelerator girdle must be capable of and is required to constraining and accurately position the mass accelerators of FIG. 1, and transmitting thrust forces generated to the surrounding cage structure and from it to the vehicle in which the invention is placed. FIG. 2a, shows the present invention having the mass accelerator girdle removed with the movable bearing arc segments 42 positioned between the two circular bearing rings.

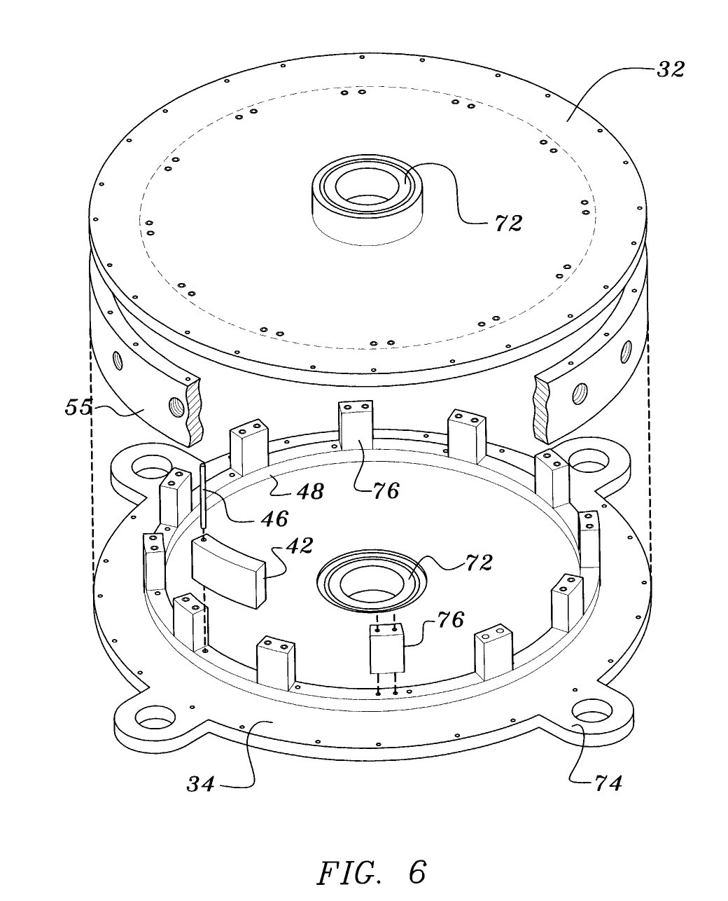

In operation, encircling the rotating disk and acting as the distal thrust masses travel stop are the thrust mass bearing races 48, with one of the races shown in FIGS. 1, 3, 3a, 4 and 6. There are two outer circular bearings, one being the top disk 32 and the other being the bottom disk 34. The outer circular bearings each have a thrust mass bearing race formed thereon. It should be understood that the thrust mass bearing race, for other designs of the device, may be a separate piece that is mounted onto the outer circular bearing. However, in the preferred embodiment of the device the thrust mass bearing and the corresponding outer circular bearing are formed from a single piece of material. Both of the thrust mass bearing rings are continuous circles machined to have the inner side as circular as possible. Each of the two circular bearing disks has an axle bearing 72 to receive the drive axle of the impulse device 10. The bottom disk has hard mounts 74 that allow the device to be mounted into the machine of choice. The movable bearing arc segments 42 are positioned on the internal surface of the bottom disk's circular bearing race 48. Immediately adjacent to each end of the movable bearing arc segments are spacers 76 that are mounted to the thrust mass bearing races and the circular bearings. These spacers are configured so as to not become a portion of the bearing races and to remain out of the path of the thrust masses as they rotate about the bearing races. The circular bearings coupled with the movable bearing arc segments form the primary cage (inner cage) for the rotating circular disk and movable thrust masses which are continuously lubricated by the circulating oil.

The impulse device can be assembled as follows: The bottom disk 34 with the circular bearing race 48 has the drive axle 22 mounted thereon. The rotating circular disk 20 is placed over the drive axle and within the bearing race. Once the rotating circular disk 20 and drive axle are in place, the thrust masses 28 are positioned in the thrust mass cavities. The spacers separating each movable bearing arc segment are mounted to the bottom circular bearing race 48. Next, the movable bearing arc segments 42 are mounted between the spacers and secured in position by a pivot shaft 46. Around each movable bearing arc segment is a grove 43 for a rubber oil seal 44 depicted in FIGS. 3 and 3a just below 46. Along the external surface of each of the movable bearing arc segments and extending therefrom is an attachment site for the pistons 64 of the mass accelerators 54. The mass accelerator girdle segments are bolted to the bottom disk 34. The girdle has a plurality of threaded bores that are aligned over the pistons. The mass accelerators 54 are screwed into the threaded bore, over a corresponding movable bearing arc segment and the mass accelerator pistons are attached to the movable bearing arc segment attachment site. The top disk 32 is then placed over the drive axle and slid into position and mounted via the axle bearing and the spacers. During this step the pivot pins for the movable bearing arc segments are slid into their matching holes in the top disk's circular bearing race 48. Once the top disk is securely in position, the bolts affixing the movable bearing arc segment spacers to the top disk are installed and the mass accelerator girdle segments are bolted to the top disk. The mass accelerators, of the assembled device, are activated according to the direction of movement, and push against the corresponding piston. The push against the piston causes the movable arc segment to rotate the acceleration hump toward the path of the thrust mass as it freely moves within the trust cavity of the rotating circular disk. The rotating circular disk being rotated by the movement of the drive axle engaged by the motor.

The inner segment of the bearing race 48 are designed to receive a repeating sequence of movable segments 42 as stated above. Each movable bearing arc segment is identically shaped and movable such that the amount of contact between this inner segment of the bearing race and the thrust masses can be varied from 0 to full contact. Each movable bearing arc segment is machined so that each has a sinusoidally shaped hump 44 that progressively shortens the radius of the inner circle of the bearing race that the thrust masses travel upon during their continuous centripetal acceleration. It is this shape that provides the additional, asymmetrical centripetal acceleration to the thrust masses' and by which the desired resulting reaction thrust/impulse force is produced. Each movable bearing arc segment of the inner bearing race is connected at one end to a piston 64 which is actuated by an externally powered mass accelerator 54 mounted to the mass accelerator girdle of the surrounding cage assembly 52 for the rotating circular disk. The other end of the movable bearing arc segment is mounted to a pivot shaft 46 that penetrates the thrust mass bearing race 48 of the two outer circular bearings 32 and 34. The distance between the apex of the hump and the center of the pivot axis is approximately ½ to ⅓ the length of the distance between the apex of the hump and the attachment point for the piston, thus taking advantage of the force multiplication effect of leverage and reducing the amount of force needed to move the movable bearing arc segments.

The movable bearing arc segments 42 can vary in number consistent with the desired spectrum of thrust vectors to be generated. The mass accelerators 54 contemplated for use with the invention presently consist of commercially available hydraulic pumps, control devices and pistons and are on a structure named as the mass accelerator girdle 55. The mass accelerator girdle completely encircles the movable thrust masses bearing races 48. The size and shape of the curvature of the acceleration hump of the movable bearing arc segment bearing surface can be machined to the intended performance output of the device and varies in magnitude with the desired thrust. Larger curvatures produce greater thrust at a given rate of disk rotation and thus the power output of the invention can be varied by the shape of the movable bearing arc segment acceleration surface and the rotational velocity of the disk. Also, the distance that the mass accelerator piston moves the movable bearing arc segment directly affects the amount of vectored thrust generated by varying the radial acceleration distance. It is contemplated that up to three adjacent mass accelerators can be simultaneously activated to produce the desired thrust.

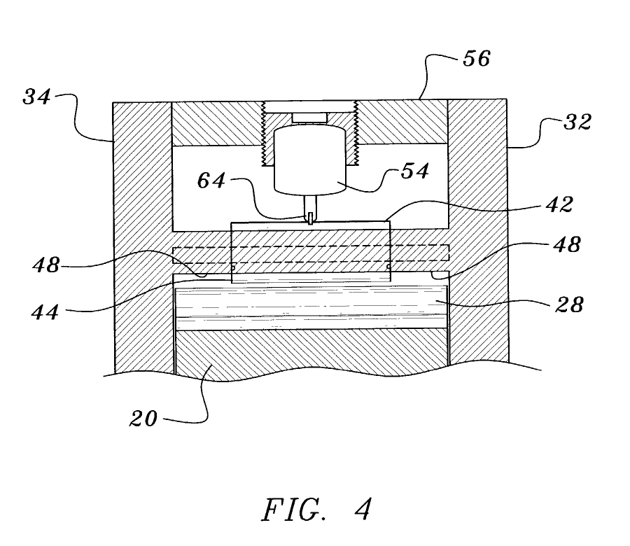

FIG. 4 shows the impulse device at rest. It is important to note that when the device is at rest the acceleration hump 44 does not engage the thrust mass 28.

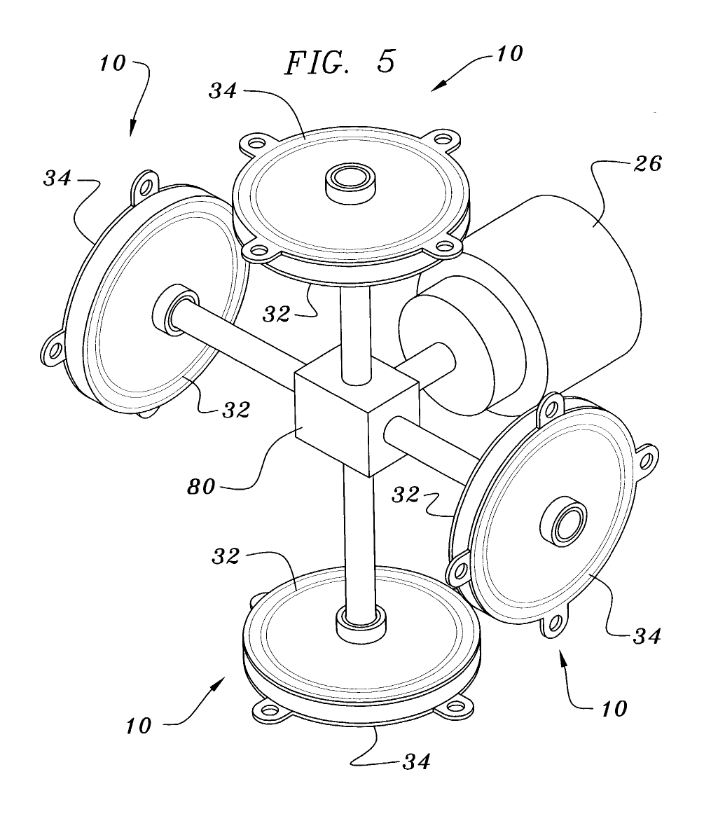

To increase thrust output and facilitate thrust vector management, multiple iterations of the device can be constructed and mounted together to operate as a single unit. For example, two complete assemblies of the invention can be mounted in parallel such that each receives power input from the same engine/motor but counter rotate. When so assembled and operated with multiple mass accelerators activated on each, the sequence of the activation of the mass accelerators can be coordinated such that any desired thrust vector is produced. This process of parallel mountings of multiple disks can be extended to achieve increased thrust amounts. Additionally, similar multiple, parallel disk mountings can be orthogonally mounted to other multiple parallel disk mountings, all receiving energy input from the same engine/motor supply. In the configuration shown in FIG. 5, the available thrust vectors describe a sphere. When using multiple devices, each device mounted to a gearbox 80 by way of the drive axle. The gearbox is attached to a power supply. This array of the devices would be most useful for moving a more massive vehicles than a single impulse device.

As the device can be configured in a variety of ways and sizes, the following tables are based upon a the device consisting of a single rotational disk 20 with a main thrust bearing race 48 diameter of 0.05 and 1 meter and having 25 and 53 thrust masses respectively equidistantly placed about the circumference of the disk, each having a rest mass of 0.05 kg. The output calculations are based upon the use a single mass accelerator and movable bearing arc segment. The thrust is generated by inducing additional, asymmetrical centripetal acceleration and the resulting additional, asymmetrical centripetal force, which via Newton's Law of action=reaction, creates the thrust. The approximate thrust output of the device for two different embodiments are set forth below.

NOTE: Impulse and thrust calculations in the following tables exclude all considerations concerning the momentum or the centrifugal acceleration of the thrust masses (tm) produced by the device and only use the rest mass of each tm and the additional centripetal acceleration induced by each active ma. Also excluded from these thrust calculations is the secondary impulse that occurs when the tm's are centrifugally accelerated by the rotational velocity of the disk and are abruptly stopped when the bearing ring is reencountered.

TABLE 1a
Performance Parameters of a .5 meter Diameter
Main Bearing Race 48 Diameter with 25 Equidistantly
Spaced .05 kg (Rest Mass) Thrust Masses - One Mass
Accelerator Active (note Mass Accelerator
will be herein after referred to as “MA”).

| QUANTITIES | 3000 RPM | | 4200 RPM | | 6000 RPM | |
|---|---|---|---|---|---|---|
| Rotational Vel. in | 78.53975 | | 109.9565 | | 157.0795 | |
| m/s | | | | | | |
| Centripetal Force | 616.84923 | N/ | 1209.04319 | N/ | 2467.39693 | N/ |
| (C_{f}) | 138.68013 | ft/lbs | 271.81726 | ft/lbs | 554.72053 | ft/lbs |
| N/ft. lbs. | | | | | | |
| Centripetal Accl. (Cₐ) | 12336.98466 | m/s² | 24180.86378 | m/s² | 49347.93864 | m/s² |
| tm Accl. Time | 2.77777⁻⁴ | /s | 1.98413⁻⁴ | /s | 1.3888⁻⁴ | /s |
| Impulse/tm @ 1 g | .4905 | N/ | .4905 | N/ | .4905 | N/ |
| Accl. | .11026 | ft/lbs | .11026 | ft/lbs | .11026 | ft/lbs |
| Impulse/tm @ 2 g | .981 | N/ | .981 | N/ | .981 | N/ |
| | .22053 | ft/lbs | .22053 | ft/lbs | .22053 | ft/lbs |
| Impulse/tm @ 3 g | 1.4715 | N/ | 1.4715 | N/ | 1.4715 | N/ |
| | .33079 | ft/lbs | .33079 | ft/lbs | .33079 | ft/lbs |
| Total Thrust @ 1 g | 613.125 | N/ | 858.375 | N/ | 1226.25 | N/ |
| | 137.83052 | ft lbs | 192.9627 | ft/lbs | 275.661 | ft/lbs |
| Total Thrust @ 2 g | 1226.25 | N/ | 1716.75 | N/ | 2452.5 | N/ |
| | 275.661 | ft/lbs | 385.9254 | ft/lbs | 551.322 | ft/lbs |
| Total Thrust @ 3 g | 1839.375 | N/ | 2575.125 | N/ | 3678.75 | N/ |
| | 413.4915 | ft/lbs | 578.8881 | ft/lbs | 826.983 | ft/lbs |

Conversion Factors for Multiple MA's active when the MA's are spaced 30° apart:
2 MA's = Total Thrust x ˜1.66
3 MA's = Total Thrust x ˜2.33

TABLE 1b
Performance Parameters of a 1 meter Diameter
Main Bearing Race 48 Diameter with 51 Equidistantly
Spaced .05 kg (Rest Mass) Thrust Masses -
One Mass Accelerator Active.

| QUANTITIES | 3000 RPM | | 4200 RPM | | 6000 RPM | |
|---|---|---|---|---|---|---|
| Rotational Vel. in | 157.0795 | | 219.913 | | 314.159 | |
| m/s | | | | | | |
| Centripetal Force | 1233.69846 | N/ | 2418.04899 | N/ | 2467.39693 | N/ |
| (C_{f}) | 277.36027 | ft/lbs | 543.62612 | ft/lbs | 554.72053 | ft/lbs |
| N/ft. lbs. | | | | | | |
| Centripetal Accl. (Cₐ) | 24673.96932 | m/s² | 48360.97987 | m/s² | 197391.75457 | m/s² |
| tm Accl. Time | 2.77777⁻⁴ | /s | 1.98413⁻⁴ | /s | 1.3888⁻⁴ | /s |
| Impulse/tm @ 1 g | .4905 | N/ | .4905 | N/ | .4905 | N/ |
| Accl. | .11026 | ft/lbs | .11026 | ft/lbs | .11026 | ft/lbs |
| Impulse/tm @ 2 g | .981 | N/ | .981 | N/ | .981 | N/ |
| | .22053 | ft/lbs | .22053 | ft/lbs | .22053 | ft/lbs |
| Impulse/tm @ 3 g | 1.4715 | N/ | 1.4715 | N/ | 1.4715 | N/ |
| | .33079 | ft/lbs | .33079 | ft/lbs | .33079 | ft/lbs |
| Total Thrust @ 1 g | 1299.825 | N/ | 1819.755 | N/ | 2599.65 | N/ |
| | 292.189 | ft/lbs | 409.0646 | ft/lbs | 584.378 | ft/lbs |
| Total Thrust @ 2 g | 2599.65 | N/ | 3639.51 | N/ | 5199.3 | N/ |
| | 584.4045 | ft/lbs | 818.1663 | ft/lbs | 1168.809 | ft/lbs |
| Total Thrust @ 3 g | 3899.475 | N/ | 5459.265 | N/ | 7798.95 | N/ |
| | 876.5935 | ft/lbs | 1227.2309 | ft/lbs | 1753.187 | ft/lbs |

Conversion Factors for Multiple MA's active when the MA's are spaced 30° apart:
2 MA's = Total Thrust x ˜1.66
3 MA's = Total Thrust x ˜2.33

NOTE: Impulse and thrust calculations in the following tables include effect of the centrifugal acceleration of the TM's which effectively increases the total acceleration of the TM's. Excluded from these thrust calculations is the secondary impulse that occurs when the tm's are centrifugally accelerated by the rotational velocity of the disk and are abruptly stopped when the bearing ring is reencountered after the acceleration hump is fully traversed. These figures are the minimum thrust values produced by the described version of the invention. All figures are approximate.

TABLE 2a
Performance Parameters of a .5 meter Diameter
(.25 m radius) Main Bearing Race 48 Diameter with 25
Equidistantly Spaced .05 kg (Rest Mass)
Thrust Masses - One Mass Accelerator Active.

| QUANTITIES | 3000 RPM | | 4200 RPM | | 6000 RPM | |
|---|---|---|---|---|---|---|
| Rotational Vel. in | 78.53975 | m/s | 109.9565 | m/s | 157.0795 | m/s |
| Centripetal Force | 1233.69846 | N/ | 2418.08637 | N/ | 4934.79386 | N/ |
| (C_{f}) | 277.36026 | ft/lbs | 543.63452 | ft/lbs | 1109.44106 | ft/lbs |
| N/ft. lbs. | | | | | | |
| Centripetal Accl. (Cₐ) | 24673.96932 | m/s² | 48361.727569 | m/s² | 98695.877281 | m/s² |
| tm Accl. Time | .000038197 | s | .000027283 | s | .000019098 | s |
| Impulse/tm @ 1 g | .53712 | N/ | .55597 | N/ | .58424 | N/ |
| Accl. | .12074 | ft/lbs | .12498 | ft/lbs | .13133 | ft/lbs |
| Impulse/tm @ 2 g | 1.02712 | N/ | 1.04597 | N/ | 1.07424 | N/ |
| | .23089 | ft/lbs | .23513 | ft/lbs | .24149 | ft/lbs |
| Impulse/tm @ 3 g | 1.51712 | N/ | 1.53597 | N/ | 1.56424 | N/ |
| | .34104 | ft/lbs | .34528 | ft/lbs | .35164 | ft/lbs |
| Total Thrust @ 1 g | 671.4 | N/ | 972.9475 | N/ | 1460.6 | N/ |
| | 150.93072 | ft lbs | 218.718598 | ft/lbs | 328.34288 | ft/lbs |
| Total Thrust @ 2 g | 1283.9 | N/ | 1830.4475 | N/ | 2685.6 | N/ |
| | 288.62072 | ft/lbs | 411.48459 | ft/lbs | 603.72288 | ft/lbs |
| Total Thrust @ 3 g | 1896.4 | N/ | 2687.9475 | N/ | 3910.6 | N/ |
| | 426.31072 | ft/lbs | 604.25059 | ft/lbs | 879.10288 | ft/lbs |

Conversion Factors for Multiple MA's active when the MA's are spaced 30° apart:
2 MA's = Total Thrust x ˜1.66
3 MA's = Total Thrust x ˜2.33

TABLE 2b
Performance Parameters of a 1 meter Diameter
(.5 m radius) Main Bearing Race 48 Diameter with
53 Equidistantly Spaced .05 kg (Rest Mass)
Thrust Masses - One Mass Accelerator Active.

| QUANTITIES | 3000 RPM | | 4200 RPM | | 6000 RPM | |
|---|---|---|---|---|---|---|
| Rotational Vel. in | 157.0795 | | 219.913 | | 314.159 | |
| m/s | | | | | | |
| Centripetal Force | 1233.69846 | N/ | 2418.04899 | N/ | 2467.39693 | N/ |
| (C_{f}) | 277.36027 | ft/lbs | 543.62612 | ft/lbs | 554.72053 | ft/lbs |
| N/ft. lbs. | | | | | | |
| Centripetal Accl. (Cₐ) | 24673.96932 | m/s² | 48360.97987 | m/s² | 197391.75457 | m/s² |
| tm Accl. Time | 2.77777⁻⁴ | s | 1.98413⁻⁴ | s | 1.3888⁻⁴ | s |
| Impulse/tm @ 1 g | .66134 | N/ | .72988 | N/ | 1.17534 | N/ |
| Accl. | .14867 | ft/lbs | .16407 | ft/lbs | .26421 | ft/lbs |
| Impulse/tm @ 2 g | 1.15134 | N/ | 1.21988 | N/ | 1.66534 | N/ |
| | .25882 | ft/lbs | .27423 | ft/lbs | .37436 | ft/lbs |
| Impulse/tm @ 3 g | 1.64134 | N/ | 1.70988 | N/ | 2.15534 | N/ |
| | .36897 | ft/lbs | .38438 | ft/lbs | .48452 | ft/lbs |
| Total Thrust @ 1 g | 1752.551 | N/ | 2707.8548 | N/ | 6229.302 | N/ |
| | 393.9755 | ft/lbs | 608.6997 | ft/lbs | 1400.313 | ft/lbs |
| Total Thrust @ 2 g | 3051.051 | N/ | 4525.7548 | N/ | 8826.302 | N/ |
| | 685.873 | ft/lbs | 1017.3933 | ft/lbs | 1984.108 | ft/lbs |
| Total Thrust @ 3 g | 4349.551 | N/ | 6343.6548 | N/ | 11423.302 | N/ |
| | 977.7705 | ft/lbs | 1426.0498 | ft/lbs | 2567.956 | ft/lbs |

Conversion Factors for Multiple MA's active when the MA's are spaced 30° apart:
2 MA's = Total Thrust x ˜1.66
3 MA's = Total Thrust x ˜2.33

What is claimed is:

1. An impulse drive device for converting inertial and rotational energy into linear motion, which comprises:
a drive axle;
a top circular bearing ring;
a bottom circular bearing ring, the top and bottom circular bearing rings are coupled to the drive axle;
a pair of thrust mass bearing race, one of the pair of thrust mass bearing race is fixedly attached to the interior of the top circular bearing ring, another of the pair of thrust mass bearing race is fixedly attached to the interior of the bottom circular bearing;
an inner circular bearing ring coupled to the pair of thrust mass bearing race and the top and bottom circular bearing rings;
means for rotating about the drive axle and within the pair of thrust mass bearing race so to engage the internal side of the inner circular bearing ring;
a surrounding cage having positioned there through a plurality of mass accelerators; and
means for sequentially activating one or more of the plurality of mass accelerators so that the activated mass accelerators engage externally a segment of the inner circular bearing so that it presses against the means rotating about the drive axle thereby producing a thrust vector that provides the amount and direction of trust.

2. The impulse drive as set forth in claim 1, wherein, the means for rotating about the drive axle includes a rotating circular disk with a plurality of thrust mass cavities, with the rotating circular disk having a central lumen through which the drive axle passes and couples with the rotating circular disk.

3. The impulse drive as set forth in claim 2, wherein, each of the plurality of thrust mass cavity has a thrust mass located therein, the thrust mass of each thrust mass cavity moves freely therein.

4. The impulse drive as set forth in claim 3, wherein, the inner circular bearing ring is comprised of;
a plurality of movable arc segments;
a plurality of spacers to separate each of the plurality of movable arc segments; and
each of the movable arc segments is pivotally coupled to each of the thrust mass bearing race allowing each movable arc segment to move into and away from the path of the thrust mass which move radially freely as the rotating circular disk is moved by the drive axle.

5. The impulse drive as set forth in claim 4, wherein each of the movable arc segments have an external surface and an internal service.

6. The impulse drive as set forth in claim 5, wherein, the internal service of each movable arc segment has an acceleration hump, with the acceleration humps engaging the thrust mass when one or more of the mass accelerators is activated; and the external surface of each of the movable arc segments has a piston coupled there to and spaced from the corresponding acceleration hump and pivot point.

7. The impulse drive as set forth in claim 6, wherein, the surrounding cage is formed by girdle segments, when each of the girdle segments couple with top and bottom circular bearing ring a mass accelerator girdle is formed.

8. The impulse drive as set forth in claim 7, wherein, the mass accelerator girdle has a plurality of threaded bores that are aligned above the pistons of the plurality of movable arc segments.

9. The impulse drive as set forth in claim 8, wherein, each threaded bore has a mass accelerator screwed therein for positioning over the corresponding piston so to receive the free portion of the piston within the piston slot of the each mass accelerator, whereby when the mass accelerator is activated it pushes against the piston which causes the movable arc segment to rotate the acceleration hump toward the thrust mass as it freely moves within the thrust cavity of the rotating circular disk.
